(19) United States
(12) Patent Application Publication
(10) Pub. No.: US 2022/0039380 A1
(43) Pub. Date: Feb. 10, 2022

(54) PEST CONTROL INCLUDING COMBINED MATING DISRUPTION AND TRAPPING

(71) Applicant: Trécé Inc., Adair, OK (US)

(72) Inventors: Bill Lingren, Adair, OK (US); Vincent James Chebny, Tulsa, OK (US); Valerie McKinney, Adair, OK (US)

(21) Appl. No.: 17/510,843

(22) Filed: Oct. 26, 2021

Related U.S. Application Data
(63) Continuation of application No. PCT/US2020/030083, filed on Apr. 27, 2020.
Application No. PCT/US2020/030083 is a continuation of application No. 16/800,821, filed on Feb. 25, 2020, now abandoned.
Application No. 16/800,821 is a continuation of application No. PCT/US2019/031386, filed on May 8, 2019.
(60) Provisional application No. 62/956,891, filed on Jan. 3, 2020.
(60) Provisional application No. 62/839,141, filed on Apr. 26, 2019.

(30) Foreign Application Priority Data
Apr. 27, 2020 (AR) 20200101185

(51) Int. Cl. A01N 31/02; A01M 1/02; A01N 63/14

(52) U.S. Cl. CPC A01N 31/02; A01N 63/14; A01M 1/02

(57) ABSTRACT

A highly effective lure for the attraction of insect species, such as codling moth, is disclosed. The lure optionally includes pear ester kairomone (DA), dimethyl nonatriene, linalool oxide, and acetic acid. This lure is optionally used to reduce populations of female insects in combination with mating disruption to improve the effectiveness of mating disruption. This combination of insect control strategies has been shown to produce unexpected synergistic benefits.

### CROSS-REFERENCE TO RELATED APPLICATIONS

This application is a continuation of PCT patent application No. PCT/US20/30083, and claims foreign priority to Argentine patent application AR 20200101185, both filed Apr. 27, 2020 and both claiming the benefit of U.S. provisional patent applications No. 62/839,141 filed on Apr. 26, 2019 and No. 62/956,891 filed Jan. 3, 2020; PCT patent application No. PCT/US20/30083 is a CIP of U.S. non-provisional patent application Ser. No. 16/800,821 filed Feb. 25, 2020 and is also a CIP of PCT patent application No. PCT/US19/31386 filed May 8, 2019. The disclosures of the above patent applications are incorporated herein by reference. The disclosures of the following US patent applications are also incorporated herein by reference: U.S. provisional patent application No. 62/810,366 filed on Feb. 25, 2019; U.S. provisional patent application No. 62/668,749 filed on May 8, 2018; U.S. non-provisional patent application Ser. No. 15/730,412 filed on Oct. 11, 2017; and U.S. non-provisional patent application Ser. No. 15/547,785 filed on Jul. 31, 2017.

### BACKGROUND

### Field of the Invention

The present invention is in the field of agricultural pest management and more particularly related to improved combinations of insect management strategies, including use of lures and mating disruption.

### Related Art

There is a large variety of insect pests that are threats to commercial crops. Control of these pests most often involves the use of insecticides. However, some methods of insect control include the use of natural compounds to disrupt the life cycles of the insects. For example, various pheromones can be used to disrupt insect mating. Pheromones and kairomones are also used to attract insects to monitoring traps. Such traps are used to detect presence of insects in agricultural areas or in agricultural commerce.

### SUMMARY OF THE INVENTION

Various embodiments of the invention relate to a new highly effective lure for the attraction of female codling moth (CM, Cydia pomonella) and/or a new approach to managing codling moth infestations using a combination of mating disruption and female reduction. The new multi-component lure has been found to be a highly effective attractant for female codling moth and in combination with a killing agent can significantly reduce the female's abundance in an agricultural setting. The ability to reduce female populations has a non-linear or exponential impact on the effectiveness of mating disruption, and other insect management techniques (pest management) producing hitherto unexpected results for insect control.

The new lure is a multi-component lure that is optionally configured to favor attraction of one sex relative to the other, e.g., females relative to males. The lure optionally includes a combination of codling moth pheromone and pear ester (DA). In an exemplary embodiment the lure comprises: Codling moth pheromone, pear ester kairomone (DA), dimethyl nonatriene (DMNT), linalool oxide (optionally in the pyranoid form), and/or acetic acid.

The new lure is optionally used in combination with mating disruption to control insect species via Mating Disruption Female Reduction (MDFR™). Because of the efficacy of the new lure it is now possible to attract females to a killing agent in quantities that greatly increase the impact of mating disruption at abundances where mating disruption was previously mostly ineffective. The combination of reducing female populations by trapping and disrupting mating results in a synergistic effect that reduces insect population by a factor greater than the sum of trapping females and disrupting mating separately.

Various embodiments of the invention include a lure configured to attract female codling moth, the lure comprising: optionally codling moth pheromone; pear ester kairomone; dimethyl nonatriene, wherein the pear ester kairomone and dimethyl nonatriene are optionally disposed in a solid emitter; linalool oxide; and acetic acid optionally in a compartment configured to store a liquid.

Various embodiments of the invention include a method of managing an insect infestation, the method comprising: placing a trap and lure in an area of the infestation, the lure being configured to attract females of the insects and thus reduce the density of females within the infestation by trapping at least a fraction of the females of the insect infestation; and providing a mating disruption compound in the area of the infestation, the mating disruption compound being configured to prevent males of the insects from mating with females of the insects in the infestation area that are not part of the trapped fraction.

The general approach of reducing the population of one sex while at the same time performing mating disruption is applicable to the control of other insect species.

### BRIEF DESCRIPTION OF DRAWINGS

FIG. 1A illustrates a three-compartment lure, according to various embodiments of the invention.

FIG. 1B illustrates a two-compartment lure, according to various embodiments of the invention

FIGS. 2A, 2B and 2C illustrate insect traps including multi-component lures, according to various embodiments of the invention.

FIG. 3 illustrates a method of controlling insects using mating disruption and female reduction, according to various embodiments of the invention.

FIG. 4 is a schematic representation of an orchard with an arrangement of dispensers and traps according to an embodiment of the present invention.

FIG. 5 is a schematic representation of an orchard with an arrangement of dispensers and traps according to another embodiment of the present invention.

FIG. 6 is a schematic representation of an orchard with an arrangement of dispensers and traps according to another embodiment of the present invention.

FIG. 7 is a schematic representation of an orchard with an arrangement of dispensers and traps according to another embodiment of the present invention.

FIG. 8 is a graph showing moth trapping results comparing prior art methods according to various embodiments of the present invention.

### DETAILED DESCRIPTION OF THE INVENTION

Embodiments of the invention include a lure including one, two or more compounds configured for attracting insects. The lure is optionally placed in an insect trap or combined with some other killing agent. For example, the lure may be used to attract insects to an insecticide source, a glue trap, an electrode, a funnel trap, a containment trap, and/or any other system configured to kill insects (e.g., poison them or retain them until they die, etc.). The lure may include a solid emitter impregnated with insect attractant compound(s). For example, a PVC (polyvinyl chloride) or septum lure configured to release one or more compounds that attract insects. The lure may include one or more compartments configured to hold insect attractant compound(s), such as liquids or oils. Such a lure may include containers optionally covered by diffusion membranes. A multi-lure can include one or more chemical impregnated solids in combination with one or more chemical containing compartments. For example, a dual lure may include a solid configured to release an insect attracting pheromone and also a compartment including acidic acid configured to enhance the attraction of the pheromone. In various embodiments, the one or more attractant compounds of the lure are optionally configured to preferentially attract one sex of an insect relative to another sex, and/or to attract insects of one life stage (e.g., larva or adult) preferentially relative to another life stage. Any combination of compartments and/or solid devices may be used together to attract insects.

In an exemplary embodiment, a DUAL lure includes pear ester kairomone, dimethyl nonatriene and linalool oxide within a solid emitter, and acidic acid within a container configured to store a liquid. The solid emitter can include PVC or any other suitable solid, e.g., plastic. The pear ester kairomone, dimethyl nonatriene and/or linalool oxide are evenly distributed throughout the solid emitter by compounding these chemicals with monomers and/or plasticizers of the solid emitter prior to addition to an extrusion device. Thus, when heated in the extrusion device the active ingredients of the lure are already thoroughly mixed.

Multi-lures including multiple compounds and optionally different containment types (solid or compartment) are useful when the compounds would adversely react chemically with each other or when they have dramatically different diffusion rates. For example, an acidic attractant compound could react with an alcohol-based attractant compound to form an ester. These reaction products can be less effective as attractants than their precursors. Thus, if such reactions are allowed to occur, the efficacy of the lure is reduced. This can result in a dramatically reduced shelf life for the lure. Reduced shelf life is avoided by placing the chemicals in different compartments and/or in different solid devices and severely limiting diffusion of attractants between the compartments. Lures of the invention can include one, two, three, four or more compartments configured to emit insect control compounds, optionally in combination of one, two, three, for or more solid emitters. The compartments and/or solid emitters may or may not be directly attached to each other. For example, they may be part of a lure included within a trap or be part of a lure attached to a same hanging device.

As used herein the term “abundance” is used to refer to the number of insects in a given area. This quantity may also be referred to as the “density” of the insects. Abundance and density may have units of insects per area.

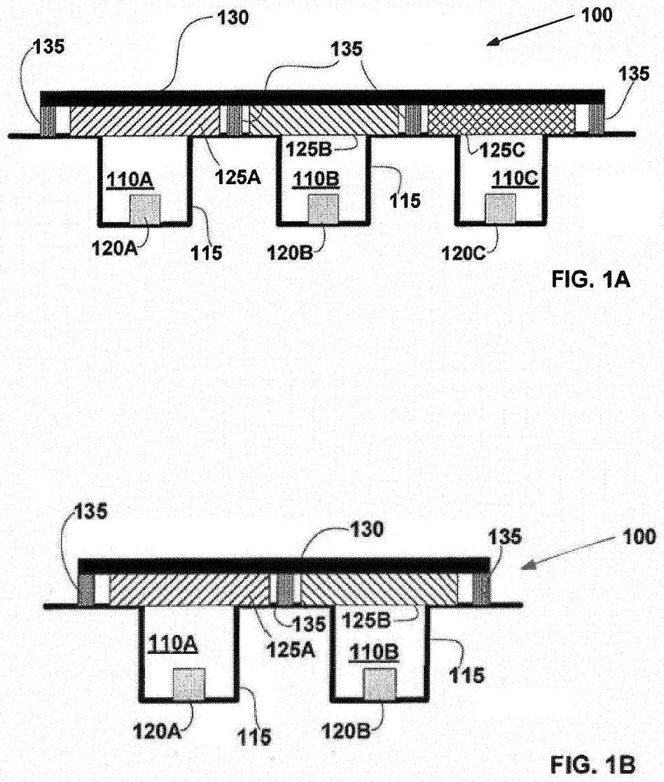

FIG. 1A illustrates a three compartment Lure 100, according to various embodiments of the invention. The three compartment embodiments of Lure 100 include three Compartments 110 individually labeled 110A, 110B and 110C. Each Compartment 110 is optionally formed by an outer Shell 115 and optionally includes a different insect Attractant 120, individually labeled 120A, 120B and 120C. Each Compartment 110 optionally further includes a Diffusion Membrane 125, individually labeled 125A, 125B and 125C. The Diffusion Membranes 125 are disposed between the Compartments 110 and an optional removable Sealing Layer 130. In some embodiments, Seals 135 are disposed between Sealing Layer 130 and Shell 115.

FIG. 1B illustrates a two compartment Lure 100, according to various embodiments of the invention. This lure includes two Compartments 110. As noted elsewhere herein any of Compartments 110 are optionally replaced by solid state emitters. In these embodiments of Lure 100, acidic Attractants 120 are optionally disposed in Compartment 110A and alcohol Attractants 120 are optionally disposed in Compartment 110B. And/Or, attractive compounds are disposed in Compartment 110A and mating disruption or other compounds are disposed in Compartment 110C.

The elements illustrated in FIGS. 1A-1B are not to scale. In alternative embodiments, one, two or three of these Compartments 110 are be replaced by solid emitters.

Compartments 110 may have curved and/or flat sides. For example, in various embodiments Compartments 110 are cylindrical, hemispherical, or rectangular. Shell 115 can be formed from a wide variety of materials, such as plastic or coated paper. A single connected Shell 115 may form all three Compartments 110 making the Compartments 110 directly connected to each other. Alternatively, two or more of the Compartments 110 may be formed from different Shells 115. If formed from different Shells 115, Compartment 110A can be disposed in a different part of an insect trap. In some embodiments, Shell 115 is also part of the structure of an insect trap, e.g., a trap lid, wall or bottom of the insect trap.

Diffusion Membrane 125 is configured to control the rates diffusion of Attractants 120 from within Compartments 110. In various embodiments, Diffusion Membranes 125 are less than 50, 10, 5 and 2 thousandths of an inch thick. In contrast, the openings of Compartments 110 covered by Diffusion Membranes 125 may be on the order of ¼ to ½ to ¾ inches (or more) in length or diameter. Part of Diffusion Membranes 125 may be masked by a less (non) permeable material to reduce the active diffusion area from one or more of Compartments 110. In various embodiments, the active diffusion area and/or openings of Compartments 110 are less than 0.1, 0.2, 0.3, 0.5, 0.6 or 0.7 inches in length or diameter, or any range between these values. In FIGS. 1A-1B Diffusion Membranes 125 are shown with different aspect ratios for illustrative purposes only. Examples of materials that may be used in Diffusion Membranes 125 are provided below. These materials can be combined as would be understood by one of ordinary skill in the art. Membrane Materials can include polyvinyl alcohol, polyacrylamide, polyurea, polyethylene, polyether, epoxy, polypropylene, polyester, ethylene vinyl acetate copolymer, polystyrene, polyamide, Polyvinylacetate, polyvinylidene chloride, polyvinyl chloride, Polyacrylate, polyacrylonitrile, chlorinated polyethylene, acetal copolymer, polyurethane, polyvinylpyrrolidone, and polymethylmethacrylate.

Different Diffusion Membranes 125 can be used to cover different members of Compartments 110. The Diffusion Membranes 125 may differ in material or thickness. The selection of Diffusion Membranes 125 can be made so as to control diffusion rates of different members of Attractants 120. In some embodiments, Diffusion Membranes 125B and 125C are the same, while Diffusion Membranes 125A is different. In some embodiments, each of Diffusion Membranes 125A, 125B and 125C are different. Diffusion Membranes 125A, 125B and/or 125C may be a single piece that spans the respective members of Compartments 110. Typically thicknesses for Diffusion Membrane 125 are at less than 0.1 mils, 5 mils, 10, mils, 25 mils, 50 mils, 100 mils, or any range between these values. Any combination of the membrane materials disclosed herein may be used for Diffusion Membranes 125A, 125B and/or 125C. One of Compartments 110 may have a different membrane than the other one or two Compartments 110, or all three of Compartments 110 may have different membranes.

The diffusion occurs through a region of each of Diffusion Membranes 125A, 125B and 125C referred to as the “active diffusion area.” The size of this active diffusion area can be controlled by masking and/or by the diameter/dimensions of Compartments 110. In some embodiments the different Diffusion Membranes 125A-125C have different active diffusion areas. For example, Diffusion Membrane 125A over Compartment 110A may have a 50% greater active diffusion area relative to Diffusion Membrane 125B over Compartment 110B. In various embodiments, the active diffusion area of one of Diffusion Membranes 125A-125C is at least 25%, 50%, 100%, 200% or 300% greater than the active diffusion area of another of Diffusion Membranes 125A-125C. Differences in active diffusion areas are optionally used to control relative release rates of different lures.

Optional removable Sealing Layer 130 is configured to prevent significant amounts of Attractants 120 from escaping from Lure 100, prior to removal of this layer. For example, Sealing Layer 130 may comprise a foil film that provides an airtight or essentially airtight seal to Compartments 110.

Optional Seals 135 are also configured for preventing mixing of Attractants 120. Seals 135 form a barrier between Compartments 110, and optionally between Compartments 110 and the exterior of Lure 100. Seals 135 may or may not penetrate Diffusion Membranes 125. Seals 135 may comprise an adhesive, plastic or other material. Alternatively, Seals 135 may be formed by heating and/or pressing on Sealing Layer 130 and/or Diffusion Membranes 125. For example, Seals 135 may be formed by a combination of pressure and heat that causes melting of Sealing Layer 130 and/or Diffusion Membranes 125.

In embodiments in which one or more compartments 110 are replaced by solid emitter devices, the shape of the solid emitter devices may be used to control rates at which insect control compounds are emitted. For example, Lure 100 can include two different solid emitting devices of different shapes, the different shapes resulting in different compound release rates.

Attractants 120 may include any compounds known to attract insects. Generally, the purpose of dividing Attractants 120 between more than one of Compartments 110 is to prevent different Attractants 120 from reacting with each other. For example, in some embodiments acidic Attractants 120 are placed in Compartment 110A and Attractants 120 having an alcohol moiety are placed in Compartment 110B.

In addition to acids and alcohols, Attractants 120 optionally further include esters and/or other compounds found to attract insects. As used herein, acidic is used to refer to a compound having a pH less than 7; alcohol is used to refer to an organic compound having a hydroxyl functional group (—OH) bound to a saturated carbon atom; “ester” is used to refer to chemical compounds derivable from an acid (organic or inorganic) in which at least one —OH (hydroxyl) group is replaced by an —O-alkyl (alkoxy) group. Examples of compounds that may be included in Attractants 120 are listed below. In addition to those listed in these tables, any suitable ester, saturated alcohol and/or saturated carboxylic acid may be used as an attractant. Further, in addition to those listed below, the esters used as attractants optionally include any suitable mono- or di-unsaturated compounds of up to 12 carbon atoms. In various embodiments, these saturated alcohol and/or saturated carboxylic acid include up to 4, up to 6 or up to 10 carbon atoms. Some embodiments further include attractants including mono or di-unsaturated compounds of up to 6 carbons.

Acidic Compounds include Acetic Acid, Formic Acid, and Propionic Acid. Alcohols include Ethanol, Methanol, Acetoin, Propanol, Methionol, Iso-propanol, Ethyl lactate, Iso-butanol, 1-hexanol, Tert-butanol, Grape butyrate, 3-hydroxybutan-2-one, Isoamyl lactate, 3-methylsulfanylpropan-1-ol, 2-phenylethanol. Esters include Isoamyl acetate, 3-hydroxybutan-2-yl formate, 2-methylbutyl acetate, 3-hydroxybutan-2-yl acetate, Ethyl sorbate, 3-hydroxybutan-2-yl propionate, Ethyl acetate, 3-hydroxybutan-2-yl butylate, Diethyl succinate, 3-methylsulfanylpropan-1-yl formate, Ethyl butyrate, 3-methylsulfanylpropan-1-yl acetate, 3-methylsulfanylpropan-1-yl propionate, 3-methylsulfanylpropan-1-yl butylate, Ethyl lactate, and Grape butyrate, Isoamyl lactate.

In various embodiments, Lure 100 includes at least two Compartments 110A and 110B. Acetic acid is disposed in Compartment 110A and any two, three or more of the other compounds are disposed in Compartment 110B. In various embodiments, Lure 100 includes at least three Compartments 110A, 110B and 110C. Acetic acid is disposed in Compartment 110A; ethanol is disposed in Compartment 110B; and acetoin and methionol are disposed in Compartment 110C. In various embodiments, Lure 110 includes at least three Compartments 110A, 110B and 110C; acetic acid is disposed in Compartment 110A; a first of the compounds is disposed in Compartment 110B; and at least a second and third of the compounds disposed in Compartment 110C. In various embodiments, a Lure 100 includes at least four Compartment 110; acetic acid disposed in a first of Compartments 110; ethanol is disposed in a second of Compartments 110; acetoin is disposed in a third of Compartments 110; and methionol is disposed in a fourth of Compartments 110. Acetoin is a solid dimer at room temp, so water, ethylene glycol, propylene glycol and other diluents can be added as a solvent. In some embodiments the solvent is selected for the resulting mixture to have an equivalent or higher vapor pressure than the solvent alone. Attractants 120 can be in solid or liquid form. The order of Compartments 110A, 110B and 110C is typically not important, and as used herein the identification of them as “first-second” or “110A-110B” etc. is not meant to indicate a requirement for an actual physical order.

Other compounds that may be included in Compartments 100A-110C include Linalool, Linalool oxide, Geraniol, b-Damascenone, a-Ionone, Benzyl alcohol, (Z)-3-hexenol, a-Ionol, Raspberry ketone, acetoin, b-Ionone, Hexanoic acid, Butyl acetate, Hexanal, 2-Heptanone, 3-Methyl-1-butanol, trans-2-Hexenal, 3-Methyl-2-butenyl acetate, 2-Heptanol, Hexanol, cis-3-Hexenol acetate, 6-Methyl-5-hepten-2-ol, β-pinene, α-pinene, Myrcene, α-phellandrene, p-cimene, β-phellandrene, γ-terpinene, caryophyllene, Humulene, Geraniol, Dihydro-β-ionone, α-Ionone, methyl acetate, limonene, hexanoic acid ethylester, and ethyl acetate. See Tables 1 and 2 for additional compounds that may be included in Lure 100.

In alternative embodiments, one or more of Attractants 120 are replaced by other compounds having other uses in insect control. For example, in a lure, various Compartments 110 and/or a solid emitter can include an insecticide, a compound configured to sterilize an insect, adhesives, killing agents, and/or an attraction inhibitor. For Codling moth, additional compounds that may be included as co-attractants include: Alpha Terpineol, beta pinene, Limonene, Gamma terpinene, and/or P-cymene.

Insecticides can include any of the compounds know in the art to kill insects. In various embodiments, insecticides are selected to target a particular insect species, genus or family Examples of insecticides include permethrin, deltamethrin, bifenthrin, Lambda cyhalothrin, malathion, and/or the like.

In various embodiments Compartment 110A includes any of the insect attractants discussed herein and Compartment 110B includes an insecticide. For example, Compartment 110A may include an attractant and Compartment 110B may include synthetic pyrethroid configured to kill insects. The combination of attractant and a killing agent disclosed herein need not be within a trap. For example, a gel including attractant and insecticide may be applied as an embodiment of Lure 100 without compartments in agricultural areas, e.g. sprayed.

Embodiments including an attraction inhibitor optionally include an attractant configured to attract one sex of a species and one or more inhibitors configured to inhibit attraction of the other sex of the species. The inhibitor, thus, increases the gender specificity of the attraction. For example, an attractant may favor attraction of females and addition of a male attraction inhibitor may further the attraction of females over males to an insecticide or trap. An advantage of using inhibitors is that it reduces attraction of both males and females of an insect to a same location. While such attraction of both sexes was inconsequential when attraction was merely used for monitoring as in the prior art, when attraction is so strong that it can be practically used for significant reduction of one sex of the insect then it is more desirable that the attraction be gender specific.

Examples of attraction inhibitors include, for example for CM and Lepidopteran family Tortricidae, (8E,10E)-8,10-dodecadien-1-yl acetate and (8E,10Z)-8,10-dodecadien-1-ol. Any of these inhibitors can be included in embodiments of Compartment 110C.

In various embodiments Compartment 110A includes any of the insect attractants discussed herein and Compartment 110C includes an attraction inhibitor configured to selectively inhibit one sex of an insect. Some embodiments include lures having an attractant in Compartment 110A, an insecticide in Compartment 110B and a gender specific attraction inhibitor in Compartment 110C.

With respect to the various compounds disclosed herein as being optionally included in Compartments 110, any of these materials may alternative be included in a solid emitter as part of the disclosed lures. Specifically, for each embodiment disclosed herein using Compartments 110 as an example, one, two, three, four or more of the Compartments 110 may be replaced by solid emitters. For example, Compartments 110A, Compartments 110B and Compartments 110C can include any combination of compartments configured to hold liquids and solid emitters. Solid emitters can include a wide variety of plastics such as PVC, and typically do not require an additional diffusion membrane. Solid emitters are optionally extruded and may have a shape configured to control the rate at which the emitted compounds important to insect control. The solid emitters optionally include any of the solid emitters of the prior art.

In some embodiments, an attractant included in a lure is a light source instead of or in addition to a chemical compound. For example, a trap may include a light source having a spectrum configured to attract insects. Such light sources are known in the art. Any of Compartments 110 discussed herein may be replaced by or include such a light source.

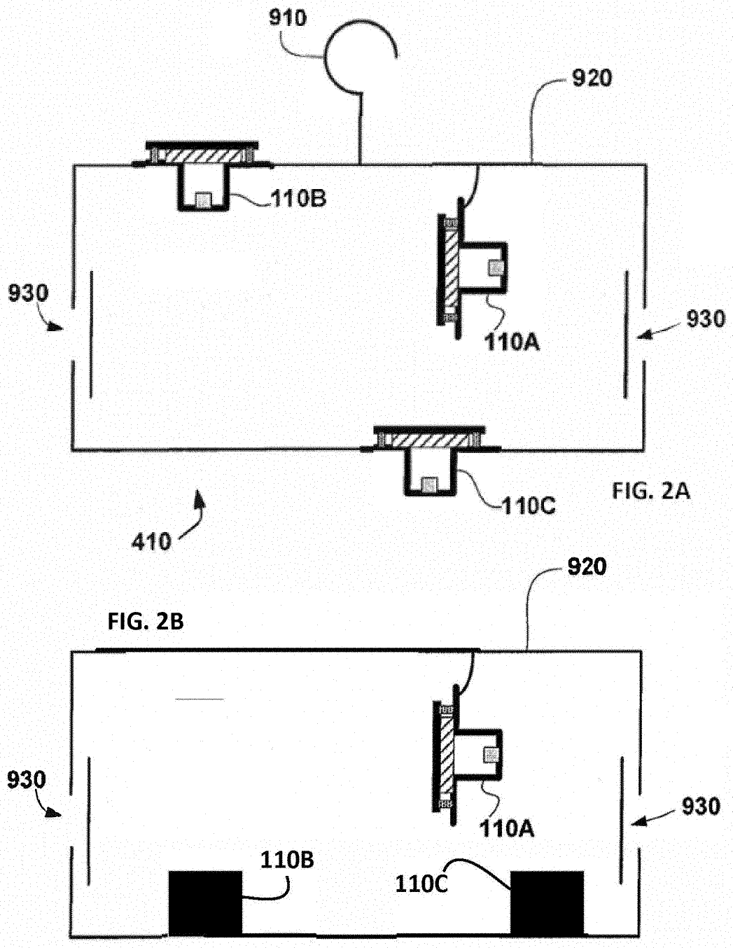

FIGS. 2A, 2B and 2C illustrate instances insect Trap 410 including one or more Lures 100, according to various embodiments of the invention. These figures provide examples of how Compartments 110 may be integrated into instances of Traps 410. While the Compartments are labeled 110A, 110B and 110C, these can be interchanged in various embodiments, and the illustrated positions of specific Compartments 110 is not intended to be limiting. Further, any of Components 110A, 110B and 110C may be replace by a solid emitter as discussed herein.

In FIG. 2A, a Trap 410 is shown to include a Hanger Hook 910, a Housing 920, one or more Container 110, Insect Entrances 930 and three Compartments 110. Any of the Compartments 110 are alternatively replaced by solid state admitters. For the purposes of example, Compartment 110A is shown hanging within the interior of Trap 410. Optionally, two, three or more Compartments 110 and/or solid emitters can be attached using this approach, with the Compartments 110/solid emitters connected and/or separate. Compartments 110B and 110C are shown integrated into a wall of Trap 410. For the purposes of example, Compartment 110B is shown at the exterior of Trap 410 and configured such that the attractant from this container will diffuse to the exterior of Trap 410 when Sealing Layer 130 is removed. Two, three or more of the Compartments 110 are optionally configured thus. For the purposes of example, Compartments 110C is shown configured such that the attractant from this container will diffuse into the interior of Trap 410 when Sealing Layer 130 is removed. Two, three or more of the Compartments 110 are optionally configured thus. Sealing Layer 130 is optionally removed prior to inserting Compartments 110 into Trap 410. However, Compartments 110 are disposed with Trap 410, they may be connected directly or separate.

FIG. 2B illustrates an embodiment of Trap 410 including Compartments 110B and 110C replaced by solid emitters configured to emit insect control compounds. Note that the solid emitters may have different shapes in order to control chemical emission rates.

FIG. 2C illustrates an embodiment of Trap 410 of a different design. This design includes a funnel trap having an adhesive Killing Agent 420. The adhesive may be replaced by other killing agents such as an insecticide patch, an oil or soap water, and/or the like.

Table 1 illustrates various compounds that may be used in combination for the control of various pests. In various embodiments, these compounds can be used in any combination of two, three or more of the listed compounds. At least one of the compounds in a combination includes an insect pheromone. This pheromone can be of the species being controlled, or of a different insect species as noted in U.S. non-provisional patent application Ser. No. 15/730,412. A combination can also include acetic acid. As noted in U.S. non-provisional patent application Ser. No. 15/547,785, the compounds used in combination are optionally disposed in a multi-compartment trap. Some embodiments include a solid dispenser configured to release mating disruption and/or attractants, and a separate acetic acid dispenser. As such, one or more of the compartments disclosed in U.S. non-provisional patent application Ser. No. 15/547,785 can be replaced by a solid dispenser.

Insects that can be controlled using the systems and methods described herein include but are not limited to: Khapra Beetle, Trogoderma inclusum; cigarette beetle, Lasioderma serricorne; CM, Cydia pomonella; OFM Grapholita molesta: PTB, Anarsia lineatella: NOW (Amyelois transitella), EGVM (Lobesia botrana), leafrollers, Pandemis limitata or Archips argyrospila; Indian meal moth Plodia interpunctella; tobacco moth, Ephestia ellutella; almond moth Cadra cautella, certain of the Noctuidae such as FAW (Spodoptera frugiperda), Heliothis or Heliocoverpa spp., boll weevil, Anthonomus grandis; pepper weevil, Anthonomus eugenii; stinkbugs, Halyomorpha halys, Nezara viridula and many others. Other species listed in Table 1 can also be controlled using the systems and methods described herein. These compounds are optionally used in MDFR strategies for insect control.

In some embodiments, a mating disruption compound is used in combination with an attractant. The mating disruption compound may target primarily one sex while the attractant targets the other sex. In a specific example, a compound that disrupts the ability of male Lepidoptera to mate with female Lepidoptera may be used in combination with a compound that attracts female Lepidoptera to a trap in order to reduce the population of female Lepidoptera.

Mating disruption compounds can be included in the same lure as female attractants. However, mating disruption compounds are optionally sprayed from a vehicle or released from point sources separate from the lures including female attractant(s). In various embodiments, the point sources are positioned at least 5, 10 or 15 feet from the lures. In various embodiments, female lures and associated traps are placed at a density of at least 1, 5, 10, 18, 25, 35 units per acre, or any range there between these values. Mating disruption compound can be released at fixed points at least 1, 12, 24, 32, 64 or 124 points/acre, or any range therebetween. Mating disruption compounds and female attractants are optionally released at different heights in an orchard canopy. For example, mating disruption compounds may be dispersed in a lower ⅔ of a canopy while female attractants are dispersed in the upper ⅓ of the canopy, or vice versa.

In some embodiments a combination of or pear ester kairomone (DA) (plus acetic acid) is used to enhance the effect of the attractants and/or mating disruptors listed in Table 1.

In some embodiments, a pheromone generated by an insect in one stage of its lifecycle is used to attract a form of that insect at another stage of its lifecycle. For example, a pheromone released by an adult female Khapra Beetle can be used to attract members of the species in the larval stage, optionally in a trap including wheat germ.

When certain combinations of compounds according to embodiments of the present invention are released from two three separate dispensers, notably including a completely separate acetic acid dispenser, they produce an order of magnitude or better increase in capture of female CM adults with a significant increase in capture of CM males or females as compared to other lures including a combination of CM pheromone and DA (pear ester). An exemplary combination of compounds is as follows: Codling moth pheromone, pear ester kairomone (DA), dimethyl nonatriene (DMNT), linalool oxide (LOX) in the pyranoid form, and/or acetic acid (AA). The acetic acid is added to the combination for improved attraction. The codling moth pheromone concentration is optionally reduced (or eliminated) to favor attraction of female codling moth relative to male codling.

Trials were conducted using crude replicas of a controlled-release lure such as one used for DMNT, the replicas consisting of small Epindorph vials with a 3 mm hole release points. These were combined with CMDA combo lures (a lure including solid PVC impregnated with DA and a source of acidic acid). Comprising other compounds in various formulations including PVC and acetic acid in a separate lure. All compounds may be compatibly combined into a single controlled release lure except acetic acid which is preferably contained in a separate controlled release lure due to its destabilizing effect on the other compounds.

Lures included in various embodiments of the invention include a unique combination of compounds have resulted in a significant increase in the capture rate of female codling moth (CM) adults. This increase in capture rate is leveraged in DMFR to exponentially increase the effectiveness of DM. The trials, using pear ester kairomone (DA), dimethyl nonatriene (DMNT), linalool oxide in the pyranoid form, and acetic acid, consistently show capture rates of more than 10 times that of CM pheromone and/or CM pheromone and kairomone (DA) combinations. The trials included lures with and without codling moth pheromone. This capture rate capacity now provides a lure that can be used in multiple ways including but not limited to monitoring, mass trapping, attract and kill (A&K) of male and female CM, or uniquely the potential for combining action systems where mating disruption is deployed along with of mass trapping devices.

Based on these attractants, which can be used to remove a high percentage of unmated and mated females from a treated area, MD is now more broadly applicable. For example, the lures disclosed herein allow for use of MD in higher density populations, wherein MD would previously have been impractical and/or ineffective. MDFR is optionally used in combination with insecticide application strategies to reduce insecticide applications which are normally used with mating disruption strategies, to reduce the number of mating disruption dispensers used and/or both approaches to result in the optimum control strategy. One may also use these “super attractant systems” (including any of the lures+traps disclosed herein) to intercept mated females arriving from nearby “dirty” orchards, rogue trees, or unmanaged infestations in any form thus enhancing further a mating disrupted environment.

Another important use of the systems and methods described herein is to allow for later application of an MD (mating disruption) system to allow that system greater longevity in a long season variety or where walnuts are at risk from a late invader such as NOW, which use CM openings as a route into the nut. This can also be an option for NOW (Navel Orange Worm) alone in almonds or pistachios. As such, the methods and systems described herein may be used to reduce NOW damage following CM infestation. Female attractants are optionally optimized for the NOW species. The embodiment is conceived of as a multi-tactical, which deploys at least two fundamental mechanisms for insect management including but not limited to male and/or female removal with emphasis on mated or unmated female removal plus mating disruption which relies heavily on false trail following by males as its primary mode of action but also in the case of the CM pheromone+DA, there is also an effect on females leading to improvements in MD results. The latter in combination with the mass trapping or attract and kill systems is conceived as being a very effective approach to codling moth management.

Several exemplary embodiments are provided below. A first such exemplary embodiment comprises a standard application of (optionally 4 to 25) lures including pear ester kairomone (DA), dimethyl nonatriene (DMNT), linalool oxide (LOX) in the pyranoid form, in a solid dispenser plus a separate acidic acid dispenser as an attractant; and CM pheromone+DA COMBO in high concentration formulation as the mating disruption compounds. The high concentration formulation (MESO) can be used at 32/acre. A lower concentration formulation is used at 200/acre or 320/acre for mating disruption. The lures are optionally distributed in a grid pattern at approximately equal distance in an orchard.

A second exemplary embodiment comprises a lower rate application of 20/acre CMDA COMBO MESO (high concentration formulation) dispensers or 150/acre CMDA COMBO puzzle piece dispensers (lower concentration formulation) as in the foregoing first embodiment. This second embodiment employs a pattern of distribution combined with ˜4 to 25/acre mass trapping devices (including the lures described herein) distributed in a grid pattern at equal distance in the orchard. A third exemplary embodiment comprises one of the other rates of CMDA COMBO MESO or puzzle piece with ˜4-25/acre mass trapping devices and an additional number of mass trapping devices, such as two to 10, outside the orchard as a barrier on the side most at risk for invasion by already mated females. This could sharply reduce the often-encountered edge effect in MD orchards where there is not protection from already mated females.

Later application of any combination of the above that will sufficiently reduce the female population by trapping/killing to allow a later application of the COMBO ACTION mating disruption systems to be optimally effective.

We have also conducted extensive mass trapping trials, some of which have been conducted in mating disrupted walnut orchards. We also used Z3 hexenyl acetate and other green leaf host plant volatiles to bolster pheromone trap capture rates. In various embodiments the compounds should be considered for use in trapping and MD of the Family Noctuidae and other insect families Table 1 includes possible attractants that may be included in Lure 100 in various embodiments of the invention.

TABLE 1

| Chemicals | CAS# | Isomers of Main Compound |
|---|---|---|
| (2E,6E)-Farnesol | 106-28-5 | (2E,6Z)-Farnesol, (2Z,8E)-Farnesol, |
| | | (2Z,6Z)-Farnesol |
| (E)-4,8 Di methyl- | 19945-61-0 | (Z)-4,8-Dimethyl-1,3,7-nonatriene- |
| 1,3,7-nonatriene- | | DMNT |
| DMNT | | |
| Limonene | 138-86-3 | (S)-Limonene, (R)-Limonene |
| Linalool Oxide | 14049-11-7 | (3R,6S)-trans-linalool oxide |
| Pyranoid | | (pyranoid), (3S,6R)-trans-linalool |
| | | oxide (pyranoid), (3R,6R)-cis- |
| | | linalool oxide (pyranoid), |
| | | (3S,6S)-cis-linalooloxide (pyranoid) |
| Linalool | 78-70-6 | (R)-Linalool, (S)-Linalool |
| (Z)-Jasmone | 488-10-8 | (E)-Jasmone |
| (E)-beta Ocimene | 3779-61-1 | (Z) beta ocimene |
| (Z)-3-hexenol | 928-98-1 | (E)-3-hexenol |
| acetic acid | 64-19-7 | NA |
| (BE,10E)-8,10- | 33958-49-9 | NA |
| dodecadien-1-ol | | |
| Ethyl (2E,4Z)-2,4- | 3025-30-7 | NA |
| decadienoate | | |

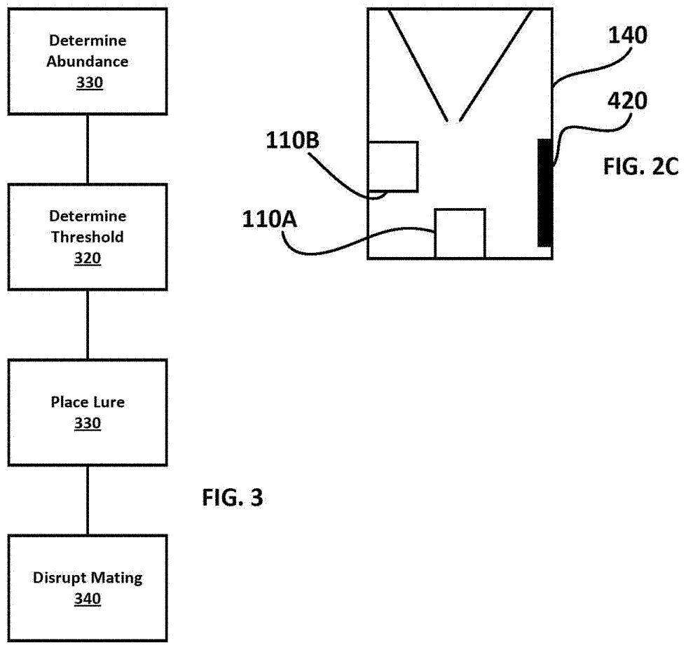

FIG. 3 illustrates a method of controlling insects using mating disruption female reduction (MDFR), according to various embodiments of the invention. This method may be adapted to include other tactics of insect control in addition to or instead of mating disruption.

In an optional Determine Abundance Step 310 abundance of an insect pest is either determined or predicted in an agricultural area. Determination may be accomplished using monitoring traps. Predictions may be made based on an infestation history, participation records, temperature measurements, and/or the like. In one embodiment, male insects are trapped prior to emergence of their female mates and the number of males trapped is used to estimate future populations of both males and females.

In an optional Determine Threshold Step 320, determining that the abundance is or will be above one or more predetermined thresholds. These thresholds may represent a sliding scale reflecting how much insect management will be required in a growing season. The higher the abundance, the greater value of additional insect management.

In a Place Lure Step 330, one or more lure, e.g., Lure 100, are placed in an area of insect infestation. The number of lures placed is optionally dependent on the amounts determined in Steps 310 and 320. Each of the lures are associated with a trap and/or some other killing agent. For example, a lure may be combined with an insecticide, optionally within a trap. As such, the attracted insects are likely killed. The lure placed in Place Lure Step 330 can include any of the lures discussed elsewhere herein.

In some embodiments, the lures placed in Place Lure Step 330 are configured to preferably attract one gender of a species. For example, Lure 100 may be configured to preferentially attract female codling moths relative to male codling moths. In various embodiments this difference in attraction can be at least 1:2, 1:3, 1:4 or 1:5 (male/female). The lure may alternatively be configured to attract European grape vine moth (EGVM), Lobesia botrana in grape (vines), navel orangeworm (NOW), Amyelois transitella, Noctuidae, fall armyworm (FAW), or Spodoptera frugiperda,

The effect of trapping and/or killing one gender of an insect is to reduce the population of that gender. Using a highly effective lure, such as Lure 100, can significantly reduce abundance/density of one or both genders of the insect. For example, a fraction of females in a population can be trapped to reduce their density within an infestation.

In a Disrupt Mating Step 340, a mating disruption compound is provided to the area of infestation. The mating disruption compound is optionally configured to prevent males of the insect species from mating with females of the species (which have not been trapped/killed). The combination of the population reduction using the lure of Place Lure Step 330 with mating disruption results in a synergistic effect that reduces insect population by a factor greater than the sum of the reductions that would be expected from female trapping alone and mating disruption alone. The trapping and/or killing of insects of one gender increases effectiveness of mating disruption compounds at disrupting codling moth mating non-linearly or exponentially as a function of a number of insects trapped, relative to mating disruption without a trap. For example, disruption of codling moth mating can be increased in a non-linear manner as a function of female codling moths trapped and/or killed, relative to mating disruption without use of trap and/or Lure 100.

Mating disruption compounds may be provided at point sources or from a moving vehicle. The point sources are optionally disposed at least 10, 50, 100 or 200 feet from the lures and killing agents, or at any range there between. Place Lure Step 330 may be performed before, after, and/or in parallel with Disrupt Mating Step 340.

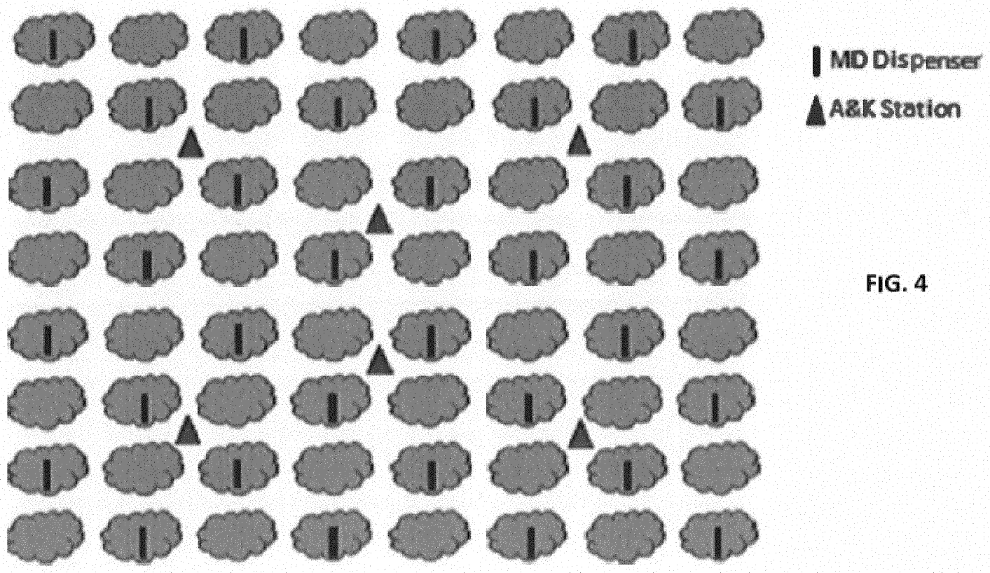

FIG. 4 illustrates an exemplary arrangement of the present invention within an orchard. The arrangement comprises traps and dispensers distributed as shown. The traps are intended to attract and kill, and the dispensers are intended for mating disruption. In the illustration, traps are represented by triangles positioned between trees, while the dispensers are shown as vertical lines on only some of the trees. A one-acre plot will include about 32 MESOs in these embodiments. The illustrated arrangement is considered a normal density arrangement herein. In FIGS. 4-7 A&K Stations include an attractant such as Lure 100, an optional trap, and a killing agent.

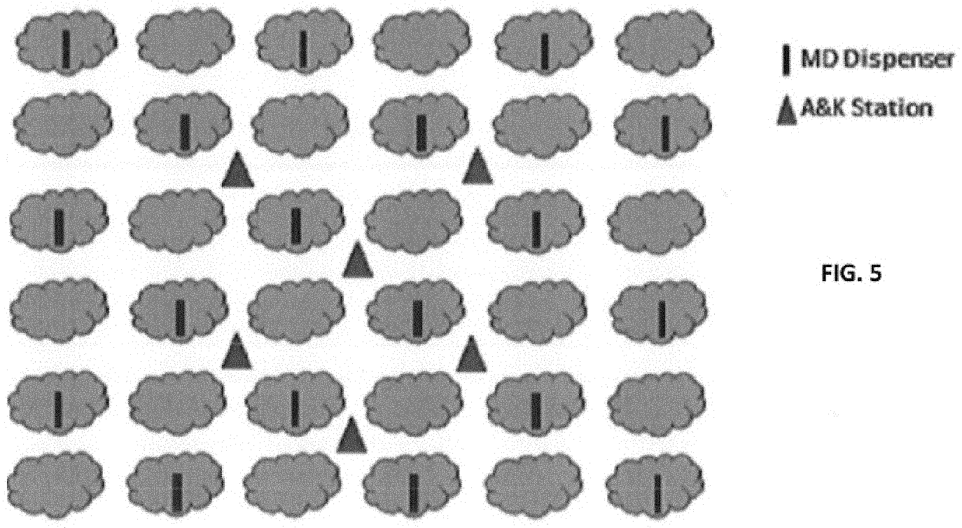

FIG. 5 illustrates another exemplary arrangement of the present invention of traps and dispensers within an orchard. These embodiments comprise about 18 MESOs per acre and is considered a low-density arrangement herein.

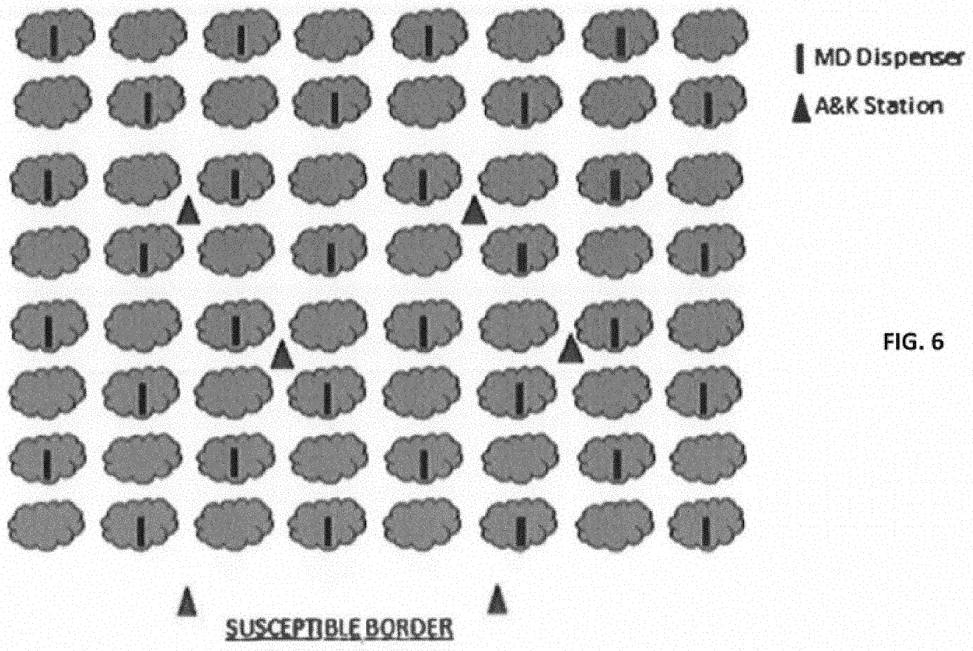

FIG. 6 illustrates another exemplary arrangement of the present invention of traps and dispensers within an orchard. In these embodiments the orchard is bounded on one side by a susceptible border. Accordingly, the arrangement places traps along the susceptible border. The arrangement shown in FIG. 3 is a normal density with 32 MESOs per acre.

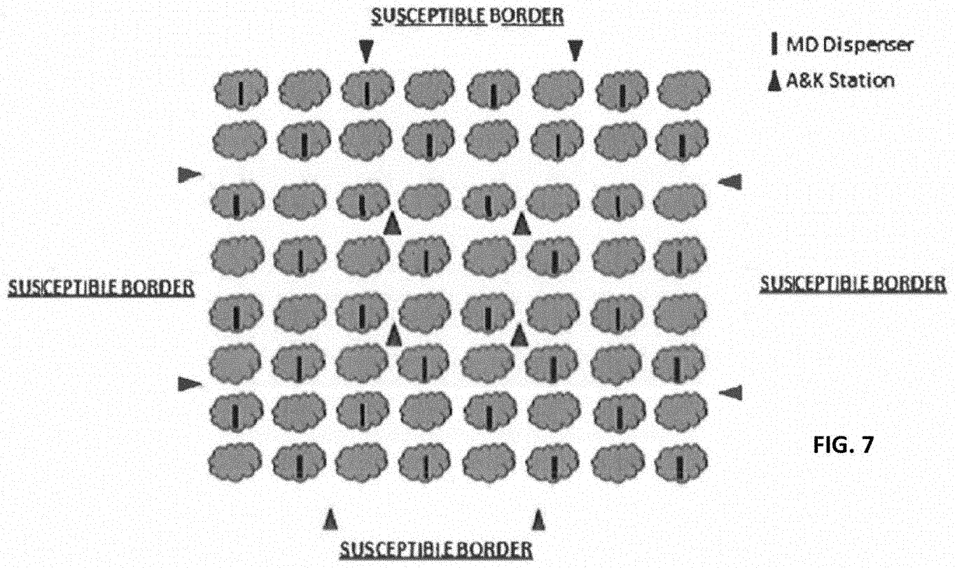

FIG. 7 illustrates another exemplary arrangement of the present invention of traps and dispensers within an orchard. In these embodiments the orchard is bounded on all sides by susceptible borders. Accordingly, the arrangement places traps along the susceptible borders. The arrangement shown in FIG. 4 is also a normal density with 32 MESOs per acre.

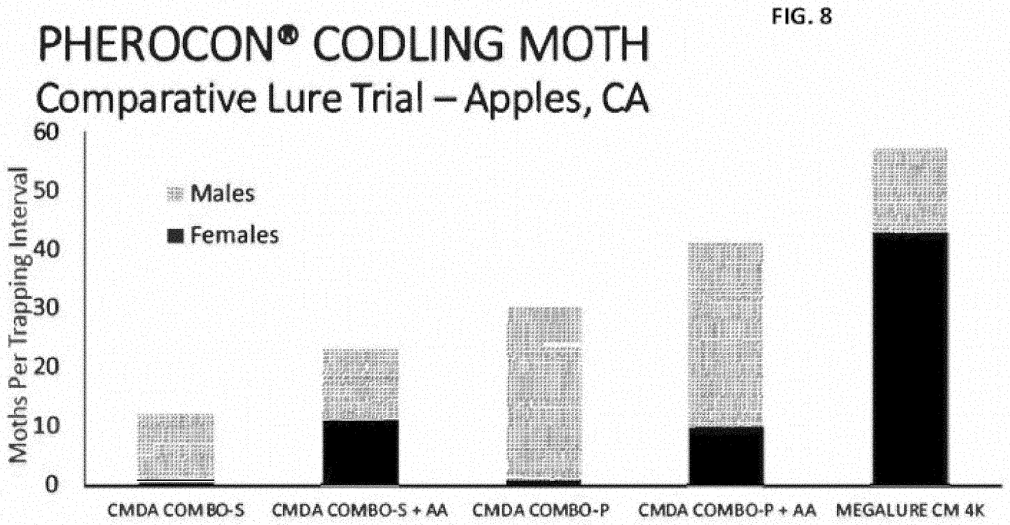

FIG. 8 is a graph showing moth trapping results comparing prior art methods to various embodiments of the present invention. An improvement in female trapping of over an order of magnitude is obtained relative to the use of just DA. Referring to the figure: CM+DA COMBO-S=S is septa substrate, the oldest form of lure substrate. CM+DA COMBO-S+AA=CMDA COMBO-S=septa plus acidic acid (AA) in the same film cup lure as with 4K. CM+DA COMBO-P=P=PVC substrate, the latest form of controlled release substrate. CMDA COMBO-P+AA=CMDA COMBO-P plus acidic acid. MEGALURE CM 4k=pear ester kairomone (DA), dimethyl nonatriene (DMNT), linalool oxide (LOX) and acidic acid.

Table 2 illustrates additional insect species and compounds that may be used to manage insects using the multi-pronged approach disclosed herein including trapping/killing of one sex of an insect using a highly attractive lure and other insect mitigation techniques, such as mating disruption. Of note are application of this approach to European grape vine moth (EGVM), Lobesia botrana in grapes (vines), navel orangeworm (NOW), Amyelois transitella, row crop insects (e.g., Noctuidae, fall armyworm (FAW), Spodoptera frugiperda, etc.), tree nut crops etc. For specific insects, any of the combinations of the compounds in Table 2 may be used in Lure 100 and/or for mating disruption.

TABLE 2
Codling Moth (CM)
Cydia pomonella (Tortricidae)

| | Typical Commerical Codling |
|---|---|
| Codling Moth Pheromone Components | Moth Pheromone Components |
| E-8,E-10-dodecadien-l-ol | E-8,E-10-dodecadien-l-ol |
| Dodecan-1-ol | Dodecan-1-ol |
| Decan-1-ol | Tetradecan-1-ol |
| Octadecanal | |
| E-9-dodecen-l-ol | |
| E-9-dodecen-l-y1 acetate | |
| E-8,E-10-dodecadienal | |
| Octadecan-1-ol | |
| Tetradecan-1-ol | |
| Hexadecan-1-ol | |
| E-8,Z-10-dodecadien-l-ol | |
| E-8-dodecen-l-ol | |
| E-8-dodecen-l-y1 acetate | |
| Z-8,E-10-dodecadien-l-ol | |
| Z-8,Z-10-dodecadien-l-ol | |
| E-8,E-10-dodecadien-l-y1 acetate | |
| Octadecan-1-yl acetate | |
| Codling Moth Kairomones | |
| Identified Pheromone Syneraists, proven (Field | |
| demonstrated): | |
| (% increase in Male capture above pheromone | |
| alone): | |
| Green Leaf Volatiles: | |
| Blend of 5 GLVs (179%): | |
| [Hexanal + | |
| (E)-2-hexenal + | |
| Hexanol + | |
| (E)-2-hexenol + | |
| (Z)-3-hexenol] | |
| Other Host Plant Volatiles (HPVs): | |
| Ethyl (2,4)(E,Z) decadienoate | |
| “Pear Ester” (180->223%) | |
| butanol (202%) | |
| 3-methyl butanol (184%) | |
| myrcene (190%) | |
| (E)-beta-ocimene (170%) | |
| gamma-terpinene (131%) | |
| terpinen-4-ol (206%) | |
| para-cymene (187%) | |
| Identified Pheromone Synergists, suggested (Lab | |
| flight tunnel demonstrated): | |
| (±) linalool (162%) | |
| (E)-beta-farnesene (157%) | |
| (Z)-3-hexenyl acetate (151%) | |
| Ethyl (2,4)(E,Z) decadienoate | |
| Ethyl (2,4)(E,Z) decadienoate | |
| R(+)-limonene | |
| (E)-beta-farnesene | |
| linalool | |
| Identified Kairomone Attractants (without | |
| pheromone), proven (Field demonstrated): | |
| Ethyl (2,4)(E,Z) decadienoate | |
| butyl hexanoate | |
| (E,E)-alpha-farnesene | |
| (E)-beta-farnesene | |
| Male Lures: | |
| (Z)-3-hexenyl acetate | |
| farnesol | |
| (E,E)-alpha-farnesene | |
| (E)-beta-farnesene | |
| dimethyl nonatriene (less females) | |
| (Z)-3-hexenyl acetate + farnesol (additive) | |
| (E)-beta-farnesene + farnesol (−99% inhibitive) | |
| Ethyl (2,4)(E,Z) decadienoate + acetic acid (283%) | |
| dimethyl nonatriene + acetic acid (300+%) | |
| (Z)-3-hexenyl acetate + acetic acid (200%) | |
| farnesol + acetic acid (177%) | |
| HPVs Enhance Ethyl (2,4)(E,Z) decadienoate - Pear | |
| Ester Attraction: | |
| (Z)-3-hexenyl acetate (additive) | |
| Ethyl (2,4)(E,Z) decadienoate + | |
| n-butyl sulfide | |
| 4-component blend: | |
| [Ethyl (2,4)(E,Z) decadienoate + | |
| acetic acid + | |
| dimethyl nonatriene + | |
| linalool oxide] | |
| Male Attraction | |
| 7-component blend (males 200-466%): | |
| [Ethyl (2,4)(E,Z) decadienoate + | |
| nonanal + | |
| decanal + | |
| dimethyl nonatriene + | |
| methyl salicylate + | |
| (Z,E)-alpha-farnesene + | |
| (E,E)-alpha-farnesene] | |
| HPVs Reduce/Inhibit Ethyl (2,4)(E,Z) decadienoate - | |
| Pear Ester Attraction: | |
| (E,E)-alpha-farnesene (−68%) | |
| (E)-beta-farnesene (−59%) | |
| farnesol (−56%) | |
| butyl hexanoate (−45%) | |
| Females Attraction: | |
| nonanal (−95%) | |
| (Z,E)-alpha-farnesene (−87%) | |
| Other Moth Species Attracted to Pear Ester: | |
| chestnut torticid species | |
| Cydia fagiglandana | |
| Cydia splendana | |
| Pammene fasciana L., and | |
| the green bud moth Hedya nubiferana | |
| Cydia pyrivora and Hedya nubiferana (Tortricidae) | |
| Synanthedon myopaeformis | |

Oriental Fruit Moth (OFM)
Grapholita molesta (Tortricidae)

| Oriental Fruit Moth Pheromone | Typical Commerical Oriental Fruit Moth |
|---|---|
| Components | Pheromone Components |
| (2)-8-dodecen-1-yl acetate | (2)-8-dodecen-1-yl acetate |
| (E)-8-dodecen-1-yl acetate | (E)-8-dodecen-1-yl acetate |
| (2)-8-dodecen-1-ol | (2)-8-dodecen-1-ol |
| dodecanol | |
| dodecyl acetate | |
| Identified Pheromone Synergists, proven | |
| (Field demonstrated): | |
| CM sex pheromone Codlemone | |
| Oriental Fruit Moth Kairomones | |
| Identified Pheromone Synergists, proven | |
| (Field demonstrated): | |
| (% increase in Male capture above | |
| pheromone alone): | |
| Green Leaf Volatiles: | |
| hexyl acetate (159%) | |
| (E)-2-hexenyl acetate (210%) | |
| (Z)-3-hexenyl acetate (258%) | |
| Other Host Plant Volatiles (HPVs): | |
| dimethyl nonatriene (427%) | |
| (E)-beta-caryophyllene (147%) | |
| Blend Nectarine Esters (185%): | |
| [ethyl hexanoate + | |
| methyl octanoate + | |
| ethyl octanoate+] | |
| Blend Peach Leaf Sesquiterpenes (157%): | |
| [beta-caryophyllene + | |
| (E,E)-alpha-farnesene + | |
| humulene] | |
| Identified Pheromone Synergists, suggested | |
| (Lab flight tunnel demonstrated): | |
| 5 component blend and | |
| these single volatiles: | |
| (Z)-3-hexenyl acetate | |
| (Z)-3-hexenol | |
| (E)-2-hexenal | |
| benzonitrile | |
| benzaldehyde | |
| Pheromone Antagonists: | |
| benzaldehyde (68%) | |
| Blend Nect. Lactones (47%): | |
| [gamma-hexalactone + | |
| gamma-decalactone + | |
| delta-decalactone] | |
| Identified Kairomone Attractants (without | |
| pheromone), proven (Field demonstrated): | |
| Terpinyl acetate (many old refs): | |
| Terpinyl acetate + | |
| (Z)-3-hexenyl acetate | |
| Terpinyl acetate synergized by: | |
| butyl hexanoate, | |
| (E)-beta-ocimene, | |
| (E)-beta-farnesene | |
| Pear ester + (E)-beta-ocimene | |
| Identified Kairomone Attractants (without | |
| pheromone), suggested (Lab bioassays): | |
| Pear Ester | |
| Leaf Roller | |
| (Tortricidae) | |
| oblique-banded leaf roller Choristoneura | |
| rosaceana (Lepidoptera, Tortricidae) | |
| Pandemis Leafroller, Pandemis pyrusana | |
| (Lepidoptera, Tortricidae) | |
| Leaf Roller Pheromone Components | Typical Leaf Roller Pheromone Components |
| (Z)-9-tetradecen-1-yl acetate | (Z)-9-tetradecen-1-yl acetate |
| (Z)-11-tetradecen-1-yl acetate | (Z)-11-tetradecen-1-yl acetate |
| (E)-11-tetradecen-1-yl acetate | |
| (E)-11-tetradecen-1-ol | |
| tetradecyl acetate | |
| (Z)-11-tetradecen-1-ol | |
| dodecyl acetate | |
| (Z)-11-tetradecen-1-al | |
| (E)-11-tetradecen-1-al | |
| Leaf Roller Kairomones | |
| Identified Pheromone Synergists, proven | |
| (Field demonstrated): | |
| Green Leaf Volatiles: | |
| Identified Kairomone Attractants (without | |
| pheromone), proven (Field demonstrated): | |
| Attracting male and female OBLR, Pandemis | |
| heparana, and Pandemis pyrusana: | |
| Blend of Acetic acid with either: | |
| 2-Phenylethanol or | |
| Phenylacetonitrile | |

Omnivorous Leafroller (OLR)
Platynota stultana (Tortricidae)

| Omnivorous Leaf Roller | Typical Omnivorous |
|---|---|
| Pheromone Components | Leaf Roller Pheromone Components |
| (Z)-11-tetradecen-1-yl acetate | (Z)-11-tetradecen-1-yl acetate |
| (E)-11-tetradecen-1-yl acetate | (E)-11-tetradecen-1-yl acetate |
| (Z)-11-tetradecen-1-ol | |
| (E)-11-tetradecen-1-ol | |
| Omnivorous Leaf Roller | |
| Kairomones | |
| Identified Pheromone Synergists, | |
| proven (Field demonstrated): | |
| Green Leaf Volatiles: | |
| (E)-2-hexenol (204%) | |
| (Z)-3-hexenol (193%) | |

Navel Orangeworm (NOW)
Almelois transitelia (Pyralidae)

| | Typical Navel Orangeworm Pheromone |
|---|---|
| Navel Orangeworm Pheromone | Components Components |
| (11Z,13Z)-hexadecadien-1-al | (11Z,13Z)-hexadecadien-1-al |
| (11Z,13Z)-hexadecadien-1-ol | (11Z,13Z)-hexadecadien-1-ol |
| (11Z,13E)-hexadecadien-1-ol | (11Z,13E)-hexadecadien-1-ol |
| (3Z,6Z,9Z,12Z,15Z)-tricosapentaene | (3Z,6Z,9Z,12Z,15Z)-tricosapentaene |
| (11Z,13Z)-hexadecadien-1-yl acetate | |
| (11E,13Z)-hexadecadienal | |
| hexadecanal | |
| (Z)-11-hexadecenal | |
| (Z)-13-hexadecenal | |
| ethyl hexadecanoate | |
| ethyl (11Z,13Z)-hexadecadienoate | |
| (3Z,6Z,9Z,12Z,15Z)-pentacosapentaene | |
| (11Z,13E)-hexadecadienal | |
| hexadecanol | |
| (11E,13Z)-hexadecadien-1-al | |
| (11Z,13E)-hexadecadien-1-al | |
| (11E,13E)-hexadecadien-1-al | |
| methyl hexadecanoate | |
| Navel Orangeworm Kairomones | |
| Identified Pheromone Synergists, proven (Field | |
| demonstrated): | |
| Phenyl propanoate | |
| Identified Kairomone Attractants (without | |
| pheromone), proven (Field demonstrated): | |
| Phenyl propanoate | |
| Blend of 6 components: | |
| Ethyl acetate + | |
| (±)-1-Octen-3-ol | |
| Ethyl benzoate + | |
| Methyl salicylate + | |
| Acetophenone + | |
| (±)-(E)-Conophthorin | |
| Identified Kairomone Attractants (without | |
| pheromone), suggested (Lab EAGs and flight | |
| tunnel demonstrated): | |
| Acetoin | |
| Methyl benzoate | |
| 2-Phenylethanol | |
| (E)-beta-Ocimene | |
| (E)-beta-Caryophyllene | |
| alpha-Humulene | |
| (E,E)-alpha-Farnesene | |
| Sabinene | |
| Sabinene hydrate | |
| (Z)-Ocimene | |
| (S)-alpha-Pinene | |
| Salicylaldehyde | |
| 4-Terpineol | |
| Linalool | |
| alpha-Terpinolene | |
| delta-3-Carene | |
| (Z)-3-Hexenol | |
| (R)-Limonene | |
| beta-Selinene | |
| Valencene | |
| 2-Heptanol | |
| Hexanol | |
| 3-Octen-2-one | |
| 2-Undecanone | |
| Decyl acetate | |
| Nonanal | |
| Decanal | |
| Heptanal | |
| Octanal | |
| Chalcogran | |

Peach Twig Borer (PTB)
Anarsia lineatella (Gelechiidae)

| | Typical Peach Twig Borer Pheromone |
|---|---|
| Peach Twig Borer Pheromone Components | Components |
| decyl acetate | (E)-5-decenol |
| (E)-4-decyl acetate | (E)-5-decenyl acetate |
| (Z)-4-decyl acetate | |
| (E)-5-decenol | |
| (E)-5-decenyl acetate | |
| (Z)-5-decenol | |
| (Z)-5-decenyl acetate | |
| (E3,E5)-decadienyl acetate | |
| (Z3,E5)-decadienyl acetate | |
| Peach Twig Borer Kairomones | |
| Identified Pheromone Synergists, proven | |
| (Field demonstrated): | |
| (% increase in Male capture above | |
| pheromone alone): | |
| Green Leaf Volatiles: | |
| hexanal | |
| (E)-2-hexenol (131%) | |
| (Z)-3-hexenol (117%) | |
| (Z)-3-hexenyl acetate (143%) | |
| Other Host Plant Volatiles (HPVs): | |
| methyl octanoate (172%) | |
| limonene (132%) | |
| (E,E)-alpha-farnesene (144%) | |
| dimethyl nonatriene (134%) | |
| Blend Nectarine Esters (166%): | |
| [ethyl hexanoate + | |
| methyl octanoate + | |
| ethyl octanoate] | |
| Blend Nect. Monoterpenes (157%): | |
| [myrcene + | |
| (E)-beta-ocimene + | |
| limonene + | |
| linalool] | |
| Blend Peach Leaf Sesquiterpenes (147%): | |
| [beta-caryophyllene + | |
| (E,E)-alpha-farnesene + | |
| humulene] | |
| Pheromone Antaqonists: | |
| Blend Nect. Lactones (68%): | |
| [gamma-hexalactone + | |
| gamma-decalactone + | |
| delta-decalactone] | |
| Blend Almond Husk Aldehydes (44%): | |
| [(E)-2-heptenal + | |
| (E,E)-2,4-heptadienal + | |
| nonanal + | |
| (E)-2-decenal + | |
| (E,E)-2,4-decadienal] | |

European Grape Vine Moth
Lobesia botrana (Tortricidae)

| European Grapevine Moth Pheromone | Typical European Grapevine Moth |
|---|---|
| Components | Pheromone Components |
| (E)-7-dodecenyl acetate | (E,Z)-7,9-dodecadien-1-yl acetate |
| (E,Z)-7,9-dodecadien-1-yl acetate | |
| (E,E)-7,9-dodecadien-1-yl acetate | |
| (Z,Z)-7,9-dodecadien-1-yl acetate | |
| (Z,E)-7,9-dodecadien-1-yl acetate | |
| (E,E)-7,9,11-dodecatrien-1-yl acetate | |
| (Z,E)-7,9,11-dodecatrien-1-yl acetate | |
| (Z,Z)-7,9,11-dodecatrien-1-yl acetate | |
| (E,Z)-7,9,11-dodecatrien-1-yl acetate | |
| (7E,9Z)-7,9-dodecadien-1-ol | |
| (Z)-9-dodecenyl acetate | |
| (E)-9-dodecenyl acetate | |
| (Z)-11-dodecenyl acetate | |
| (E)-11-dodecenyl acetate | |
| Tetradecyl acetate | |
| Octadecan-1-ol | |
| Eicosan-1-ol | |
| European Grapevine Moth Kairomones | |
| Identified Pheromone Synergists, suggested | |
| (Lab Flight Tunnel demonstrated): | |
| Green Leaf Volatiles: | |
| Flight Tunnel: | |
| All behaviors: | |
| (Z)-3-hexenyl acetate | |
| hexan-1-ol | |
| activation only: | |
| (Z)-3-hexenol | |
| Other Host Plant Volatiles (HPVs): | |
| Flight Tunnel: | |
| All behaviors: | |
| (E)-beta-caryophyllene | |
| 1-octen-3-ol | |
| activation only: | |
| dimethyl nonatriene | |
| (E)-beta-farnesene | |
| methyl salicylate | |

European Grape Berry Moth
aka The Vine Moth
Eupoecilia ambiguella (Tortricidae)

| European Grape Berry Moth Pheromone | Typical European Grape Berry Moth |
|---|---|
| Components | Pheromone Components |
| (Z)-9-dodecen-1-yl acetate | (Z)-9-dodecen-1-yl acetate |
| (E)-9-dodecen-1-yl acetate | |
| (Z)-9-dodecen-1-ol | |
| (E)-9-dodecen-1-ol | |
| dodecyl acetate | |
| tetradecyl acetate | |
| hexadecyl acetate | |
| octadecyl acetate | |
| (E)-9,11-dodecadien-1-yl acetate | |
| European Grape Berry Moth Kairomones | |
| Identified Pheromone Synergists, suggested (Lab | |
| Flight Tunnel demonstrated): | |
| Green Leaf Volatiles: | |
| Flight Tunnel: | |
| (Z)-3-hexenol | |
| Other Host Plant Volatiles (HPVs): | |
| Flight Tunnel: | |
| terpinen-4-ol | |
| (E)-beta-caryophyllene | |
| methyl salicylate | |

Indian Meal Moth (IMM)

| | Typical Indian Meal Moth Pheromone |
|---|---|
| Indian Meal Moth Pheromone Components | Components |
| (Z,E)-9,12-tetradecadienyl acetate | (Z,E)-9,12-tetradecadienyl acetate |
| (Z,Z)-9,12-tetradecadienyl | |
| (E,E)-9,12-tetradecadienyl | |
| (E,Z)-9,12-tetradecadienyl | |
| (Z,E)-9,12-tetradecadienal | |
| (Z,Z)-9,12-tetradecadienal | |
| (E,E)-9,12-tetradecadienal | |
| (E,Z)-9,12-tetradecadienal | |
| (Z,E)-9,12-tetradecadienol | |
| (Z,Z)-9,12-tetradecadienol | |
| (E,E)-9,12-tetradecadienol | |
| (E,Z)-9,12-tetradecadienol | |
| (Z)-9-tetradecenyl acetate | |
| (E)-9-tetradecenyl acetate | |

Corn Earworm (CEW)
Helocoverpa zea (Noctuidae)

| | Typical Corn Earworm Pheromone |
|---|---|
| Corn Earworm Pheromone Components | Components |
| (Z)-11-Hexadecenal | (Z)-11-Hexadecenal |
| (Z)-9-Hexadecenal | (Z)-9-Hexadecenal |
| (Z)-9-Hexadecenal | (Z)-9-Hexadecenal |
| Hexadecanal | Hexadecanal |
| Hexadecanol | |
| (Z)-11-Hexadecenol | |
| Corn Earworm Kairomones | |
| Identified Pheromone Svneraists, proven (Field demonstrated): | |
| (% increase in Male capture above pheromone | |
| alone): | |
| Green Leaf Volatiles | |
| hexanal (237%) | |
| (E)-2-hexenal (176%) | |
| (Z)-3-hexenol (128%) | |
| hexyl acetate (176%) | |
| (E)-2-hexenyl acetate (190%) | |
| (Z)-3-hexenyl acetate (298%) | |
| (Z)-3-hexenyl acetate (259%) | |
| Other Host Plant Volatiles (HPVs): | |
| heptan-2-ol (283%) | |
| nonanal (219%) | |
| (R)-(+)-alpha-pinene (348%) | |
| (S)-(−)-alpha-pinene (215%) | |
| limonene (150%) | |
| alpha-phellandrene (152%) | |
| beta-phellandrene (342%) | |
| (E)-beta-ocimene (141%) | |
| dimethyl nonatriene (357%) | |
| (E)-beta-farnesene (363%) | |
| (E)-beta-caryophyllene (344%) | |
| alpha-(E)-bergamotene (285%) | |
| humulene (220%) | |
| (E)-nerolidol (193%) | |
| phenyl acetaldehyde (216%) | |
| methyl salicylate (172%) | |
| methyl jasmonate (255%) | |
| Chemoreception Single-Cell Synergism: | |
| (Z)-3-hexenol | |
| linalool | |
| Blossom Volatiles | |
| Gaura Volatiles: | |
| phenyl acetaldehyde (216%) | |
| 2-methyl butanal oxime (196%) | |
| Pheromone Antagonists: | |
| nonan-2-ol | |
| Blossom Volatiles | |
| Gaura Volatiles: | |
| phenyl acetaldehyde (216%) | |
| 2-methyl butanal oxime (196%) | |

Cabbage Looper (CL)
Tricoplusia ni (Noctuidae)

| | Typical Cabbage Looper |
|---|---|
| Cabbage Looper Pheromone Components | Pheromone Components |
| | (Z)-11-hexadecen-1-yl |
| (Z)-11-hexadecen-1-yl acetate | acetate |
| (E)-11-hexadecen-1-yl acetate | |
| tetradecyl acetate | |
| hexadecyl acetate | |
| Cabbage Looper Kairomones | |
| Identified Pheromone Synergists, proven (Field | |
| demonstrated): | |
| (% increase in Male capture above pheromone alone): | |
| Green Leaf Volatiles: | |
| hexanol (132%) | |
| (E)-2-hexenol (112%) | |
| (Z)-3-hexenol (152%) | |
| Other Host Plant Volatiles (HPVs): | |
| phenyl acetaldehyde (188%) | |
| Blossom Volatiles | |
| Gaura Volatiles: | |
| phenyl acetaldehyde (188%) | |
| 2-phenylethanol (131%) | |
| 2-methyl butanal oxime (196%) | |
| Both PhAcAl + 2-MBAIOx (398%) | |
| Identified Kairomone Attractants (without pheromone), | |
| proven (Field demonstrated): | |
| Blossom Volatiles | |
| Gaura Volatiles: | |
| methyl 2-methoxybenzoate | |
| phenyl acetaldehyde | |
| 2-phenylethanol | |
| 2-methyl butanal oxime | |

Tobacco Budworm (TBW)
Heliothis virescens (Noctuidae)

| | Typical Tobacco Budworm Pheromone |
|---|---|
| Tobacco Budworm Pheromone Components | Components |
| (Z)-11-Hexadecenal | (Z)-11-Hexadecenal |
| (Z)-7-Hexadecenal | (Z)-9-Hexadecenal |
| (Z)-9-Hexadecenal | |
| Hexadecanal | |
| tetradecanal | |
| (Z)-9-tetradecenal | |
| (Z)-11-Hexadecenol | |
| Tobacco Budworm Kairomones | |
| Identified Pheromone Synergists, proven | |
| (Field demonstrated): | |
| (% increase in Male capture above | |
| pheromone alone): | |
| Green Leaf Volatiles | |
| (E)-2-hexenyl acetate (183%) | |
| (Z)-3-hexenyl acetate (217%) | |

Armyworm (AW)
Pseudaletia unipuncta
(Noctuidae)

| Armyworm Pheromone | Typical Armyworm Pheromone |
|---|---|
| Components | Components |
| (Z)-11-hexadecen-1-yl acetate | (Z)-11-hexadecen-1-yl acetate |
| (Z)-11-hexadecen-1-ol | |
| (E)-11-hexadecen-1-yl acetate | |
| (E)-11-hexadecen-1-ol | |
| (Z)-9-hexadecen-1-yl acetate | |
| Armyworm Kairomones | |
| Identified Pheromone Svneraists, | |
| proven (Field demonstrated): | |
| (% increase in Male capture above | |
| pheromone alone): | |
| Green Leaf Volatiles | |
| Blend of: | |
| [hexanal + | |
| (E)-2-hexenal] | |
| Blend of: | |
| [hexanol + | |
| (E)-2-hexenol + | |
| (Z)-3-hexenol] | |
| Blend of: | |
| [hexyl acetate + | |
| (E)-2-hexenyl acetate + | |
| (Z)-3-hexenyl acetate] | |

Varigated Cutworm (VCW)
Peridroma saucia (Noctuidae)

| Varigated Cutworm Pheromone | Typical Varigated Cutworm Pheromone |
|---|---|
| Components | Components |
| (Z)-11-hexadecen-1-yl acetate | (Z)-11-hexadecen-1-yl acetate |
| (Z)-9-tetradecen-1-yl acetate | (Z)-9-tetradecen-1-yl acetate |
| Varigated Cutworm Kairomones | |
| Identified Pheromone Synergists, | |
| proven (Field demonstrated): | |
| (% increase in Male capture above | |
| pheromone alone): | |
| Green Leaf Volatiles (GLVs) | |
| Blend of: | |
| [hexanal + | |
| (E)-2-hexenal] | |
| Blend of: | |
| [hexanol + | |
| (E)-2-hexenol + | |
| (Z)-3-hexenol] | |
| Blend of: | |
| [hexyl acetate + | |
| (E)-2-hexenyl acetate + | |
| (Z)-3-hexenyl acetate] | |

Diamond Back Moth (DMD)
Plutella xylostella
(Yponomeutidae)

| Diamond Back Moth Pheromone | Typical Diamond Back Moth Pheromone |
|---|---|
| Components | Components |
| (Z)-11-hexadecen-1-al | (Z)-11-hexadecen-1-al |
| (Z)-11-hexadecen-1-yl acetate | (Z)-11-hexadecen-1-yl acetate |
| (Z)-11-hexadecen-1-ol | (Z)-11-hexadecen-1-ol |
| (Z)-9-tetradecen-1-yl acetate | |
| Diamond Back Moth Kairomones | |
| Identified Pheromone Synergists, | |
| proven (Field demonstrated): | |
| (% increase in Male capture above | |
| pheromone alone): | |
| Green Leaf Volatiles: | |
| Hexanoic acids | |
| Hexenoic acids | |
| (Z)-3-hexenyl acetate (120-130%) | |
| Blend of (175%): | |
| [(Z)-3-hexenyl acetate + | |
| (Z)-3-hexenol + | |
| allyl isothiocyanate] | |
| Single volatile: | |
| (Z)-3-hexenyl acetate (146%) | |
| Blend of (154%): | |
| [(Z)-3-hexenyl acetate + | |
| (Z)-3-hexenol + | |
| (E)-2-hexenal] | |
| Single volatile: | |
| (Z)-3-hexenyl acetate (137%) | |

Beet Armyworm (BAW)
Spodoptera exigua (Noctuidae)

| Beet Army Worm Pheromone | Typical Beet Army Worm |
|---|---|
| Components | Pheromone Components |
| tetradecan-1-ol | (Z,E)-9,12-tetradecadien-l-yl acetate |
| (Z)-9-tetradecen-l-ol | (Z)-9-tetradecen-l-ol |
| (E)-9-tetradecen-l-ol, | |
| (Z,E)-9,12-tetradecadien-l-ol | |
| (Z,Z)-9,12-tetradecadien-l-ol | |
| tetradecan-1-yl aceate | |
| (Z)-9-tetradecen-l-yl acetate | |
| (E)-9-tetradecen-l-yl acetate | |
| (Z,E)-9,12-tetradecadien-l-yl acetate | |
| (Z,Z)-9,12-tetradecadien-l-yl acetate | |
| (Z)-7-tetradecen-l-ol acetate | |
| Beet Armyworm Kairomones | |
| Identified Pheromone Synergists, | |
| proven (Field demonstrated): | |
| (% increase in Male capture above | |
| pheromone alone): | |
| Green Leaf Volatiles: | |
| hexanal (107%) | |
| (E)-2-hexenal (123%) | |
| Lab EAGs Synergism: | |
| (E)-2-hexenol | |
| (Z)-3-hexenol | |
| (E)-2-hexenyl acetate | |
| (Z)-3-hexenyl acetate | |
| Field & Flight Tunnel: | |
| (E)-2-hexenal (139%) | |
| phenylacetaldehyde (135%) | |
| (Z)-3-hexenyl acetate (125%) | |
| (Z)-3-hexenol (121%) | |

Several embodiments are specifically illustrated and/or described herein. However, it will be appreciated that modifications and variations are covered by the above teachings and within the scope of the appended claims without departing from the spirit and intended scope thereof. For example, while the use of Lure 100 has been discussed in combination with mating disruption. This unique lure can alternatively be used with other insect mitigation strategies. For example, the lure can be used with any combination of mating disruption, insecticides, inundated releases of biological organisms such as beneficial insects, and/or other insect control techniques.

Lure 100 can include additional Compartments 110 and can contain compounds other that insect attractants. These compounds can include dyes, chemical markers, insect trapping adhesives, inhibitors, materials for insect control, insecticides, pheromones, kairomones and/or necromones.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A lure configured to attract female codling moth, the lure comprising:
a solid emitter impregnated with both pear ester kairomone and dimethyl nonatriene;
linalool oxide; and
acetic acid.

2. The lure of claim 1, further comprising codling moth pheromone.

3. The lure of claim 1, wherein the linalool oxide is in the pyranoid form.

4. The lure of claim 1, wherein acetic acid is disposed in a liquid dispenser.

5. The lure of claim 1, wherein a shape and matrix of the solid emitter is used to control release rate of the pear ester.

6. The lure of claim 1, wherein the lure preferentially attracts female codling moth relative to male codling moth, at a rate of at least 2:1.

7. The lure of claim 1, further comprising a killing agent effective to kill codling moth.

8. The lure of claim 7, wherein the killing agent includes an insecticide.

9. The lure of claim 1, further comprising an attraction inhibitor effective to inhibit attraction of male codling moth and increase selectivity of female codling moth attraction by the lure.

10. A trap configured to capture female codling moth comprising the lure of claim 1.

11. The trap of claim 10, further comprising a mating disruption compound effective to disrupt mating of codling moth.

12. The trap of claim 11, wherein the mating disruption compound includes at least one of codling moth pheromone and pear ester.

13. The trap of claim 11, wherein the trap is effective to increase an effectiveness of the mating disruption compound at disrupting codling moth mating exponentially as a function of a number of female codling moths trapped.

14. The trap of claim 11, wherein the trap is effective to increase effectiveness of the mating disruption compound at disrupting codling moth mating non-linearly as a function of a number of female codling moths trapped.

15. The trap of claim 11, wherein the trap in combination with the mating disruption compound results in a synergistic effect that reduces codling moth population by a factor greater than the sum of separate female trapping females and mating disruption.

16. The trap of claim 11, further comprising an attraction inhibitor configured to inhibit attraction of male codling moth and increase selectivity of female codling moth attraction by the lure.

17. A method of managing an insect infestation, the method comprising:
placing a trap and lure in an infestation area, the lure being effective to attract females of the insects to the trap in order to trap a fraction of the females of the insect infestation to reduce a density of the females within the infestation area; and
providing a mating disruption compound in the infestation area, the mating disruption compound being effective to prevent males of the insects from mating with females of the insects in the infestation area that are not part of the trapped fraction.

18. The method of claim 17, further comprising:
predicting the density of the female insects within the infestation area to derive a predicted density; and
wherein placing the trap and lure in the infestation area is responsive when the predicted density exceeds a threshold.

19. The method of claim 18, wherein predicting the density of the female insects is dependent on an infestation history and temperature measurements.

20. The method of claim 18, wherein predicting the density of the female insects is dependent on a number of male insects trapped.

21. The method of claim 17, wherein the trap in combination with the mating disruption compound results in a synergistic effect that reduces codling moth population by a factor greater than the sum of separate female trapping females and mating disruption.

22. The method of claim 17, wherein the trap increases an effectiveness of the mating disruption compound at disrupting codling moth mating non-linearly or exponentially as a function of a number of female codling moths trapped, relative to mating disruption without the trap.

23. The method of claim 17, wherein the trap and lure are placed in the infestation area prior to providing the mating disruption compound in the infestation area.

24. The method of claim 17, wherein the trap and lure are placed between 10 and 200 feet from a source of the mating disruption compound.

25. The method of claim 17, wherein the insect is codling moth, European grape vine moth, Lobesia botrana in grape (vines), navel orangeworm, Amyelois transitella, Noctuidae, fall armyworm, or Spodoptera frugiperda.
